(19) United States
(12) Patent Application Publication
(10) Pub. No.: US 2016/0035251 A1
(43) Pub. Date: Feb. 4, 2016

(54) CRANE OPERATOR GUIDANCE

(71) Applicant: Trimble Navigation Limited, Sunnyvale, CA (US)

(72) Inventor: Jean-Charles Delplace, Longueil Sainte Marie (FR)

(21) Appl. No.: 14/448,421

(22) Filed: Jul. 31, 2014

(51) Int. Cl. G09B 19/16; G09B 9/05; G09B 19/00; G09B 9/042

(52) U.S. Cl. CPC G09B 19/167; G09B 9/042; G09B 9/05; G09B 19/003

(57) ABSTRACT

A method for providing guidance to a crane operator is described and includes: accessing identification information for a set of objects to be moved at a worksite and by a crane; accessing inventory information associated with the worksite, wherein the inventory information includes a location of the inventory at the worksite; accessing routing information associated with the worksite, wherein the routing information includes a set of routes available for movement of the inventory, wherein the inventory includes the set of objects; based on the identification information, the inventory information and the routing information, generating a lift plan for the set of objects, wherein the lift plan comprises a target destination and a target route for the set of objects; and generating a 3-D simulation of the lift plan, wherein the 3-D simulation comprises a set of indicators providing an enhanced guidance for a movement of the set of objects.

### BACKGROUND

Lifting devices, such as cranes, are employed to hoist or lift objects to great heights. The lifting device may be employed at a location such as a construction site. The construction site may have many different objects and types of objects or assets associated with the construction type such as equipment, beams, lumber, building material, etc. The objects may or may not be moved by the lifting device. The crane may swivel or pivot about a pivot point to allow the crane to lift and move objects into position. The crane operator must make decisions as to where to place an object once lifted. Further, sometimes the crane operator must move an object through an area which is blocked from his view. Thus, in various situations, the crane operator needs guidance as to where to move an object and the path the crane should take to move such an object.

### BRIEF DESCRIPTION OF THE DRAWINGS

The accompanying drawings, which are incorporated in and form a part of this application, illustrate and serve to explain the principles of embodiments in conjunction with the description. Unless noted, the drawings referred to this description should be understood as not being drawn to scale.

FIGS. 1A and 1B are block diagrams of a tower crane system and a luffer crane, respectively, in accordance with embodiments of the present technology.

FIG. 2 is a block diagram of an environment with a crane, in accordance with an embodiment of the present technology.

FIG. 3 is a block diagram of a crane operator guidance system, in accordance with an embodiment of the present technology.

FIG. 4 is a block diagram of a crane operator guidance system, in accordance with an embodiment of the present technology.

FIG. 5 is a flowchart of a method for providing guidance to a crane operator, in accordance with an embodiment of the present technology.

FIG. 6 is a block diagram of an example computer system upon which embodiments of the present technology may be implemented.

FIG. 7 is a block diagram of an example global navigation satellite system (GNSS) receiver which may be used in accordance with embodiments of the present technology.

### DESCRIPTION OF EMBODIMENT(S)

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

Unless specifically stated otherwise as apparent from the following discussions, it is appreciated that throughout the present description of embodiments, discussions utilizing terms such as “accessing”, “generating”, “presenting”, or the like, often refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, mobile communication devices.

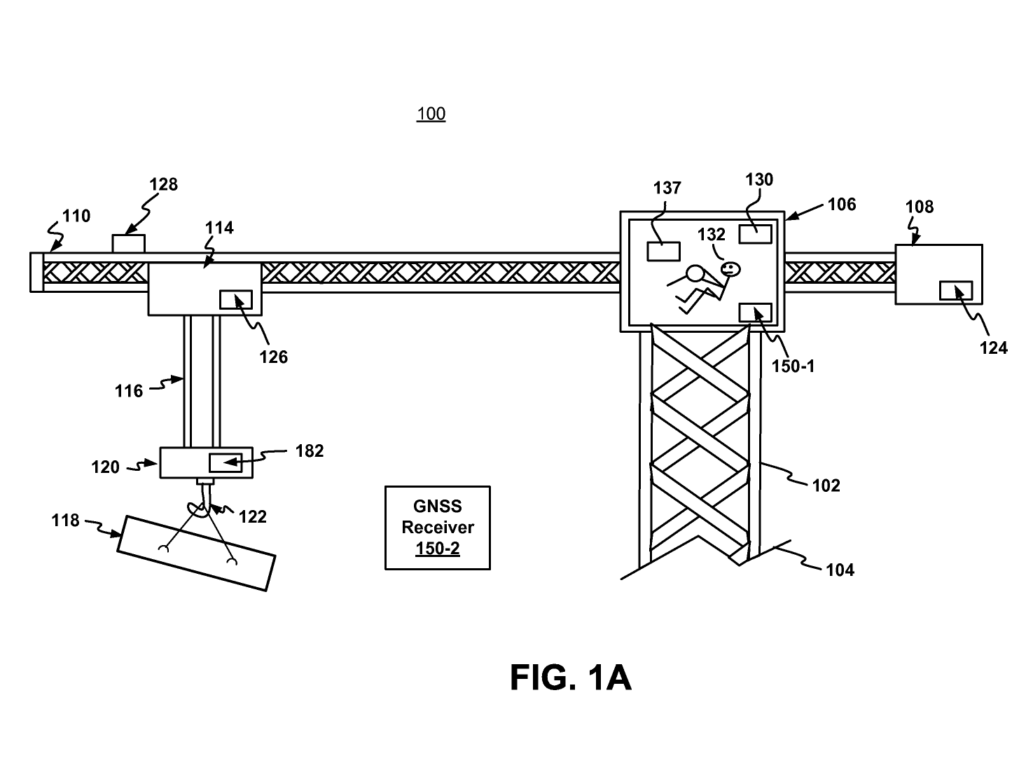

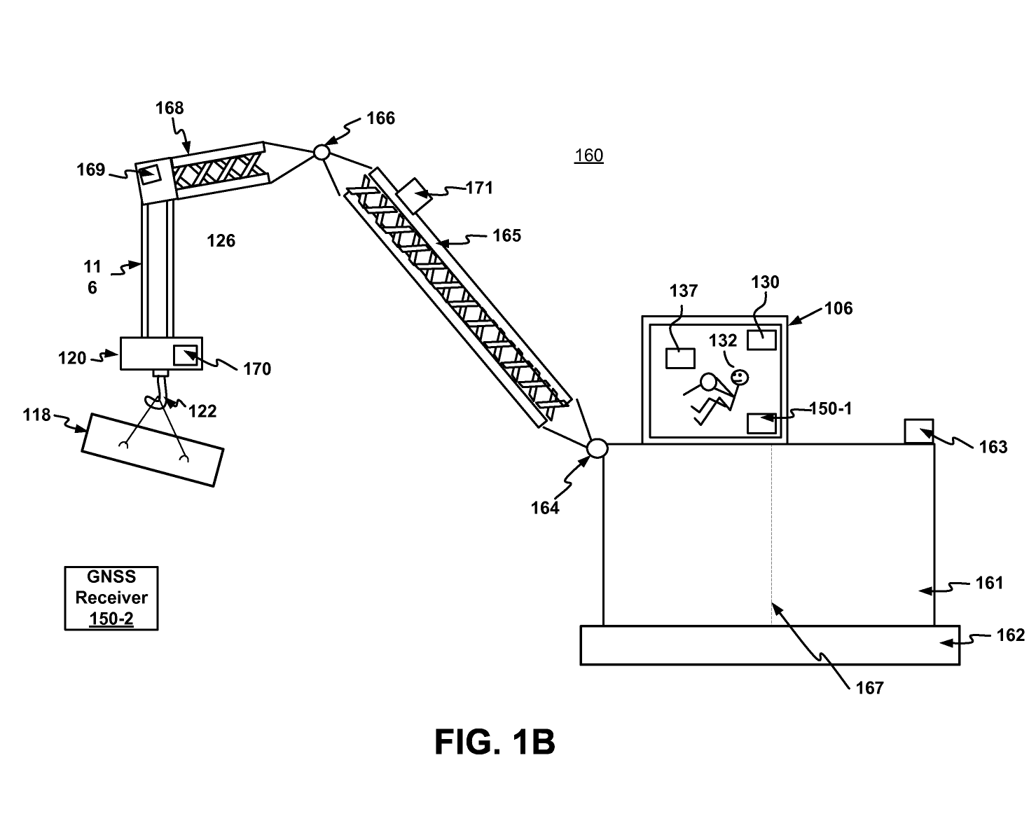

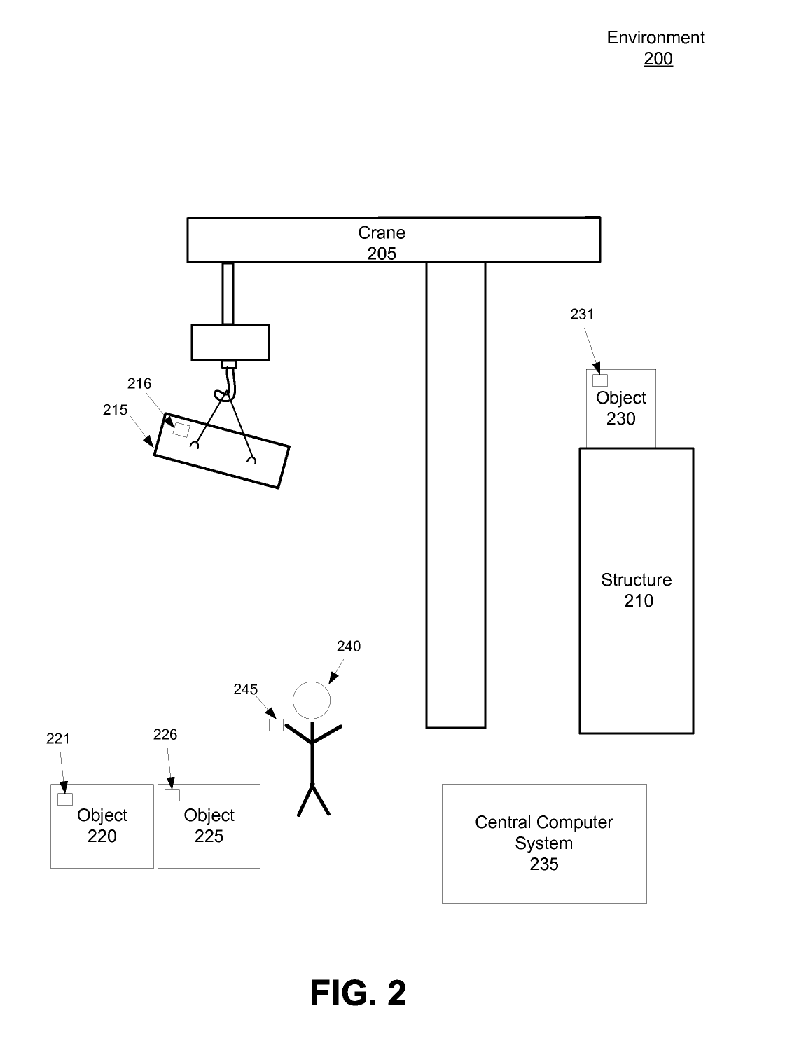

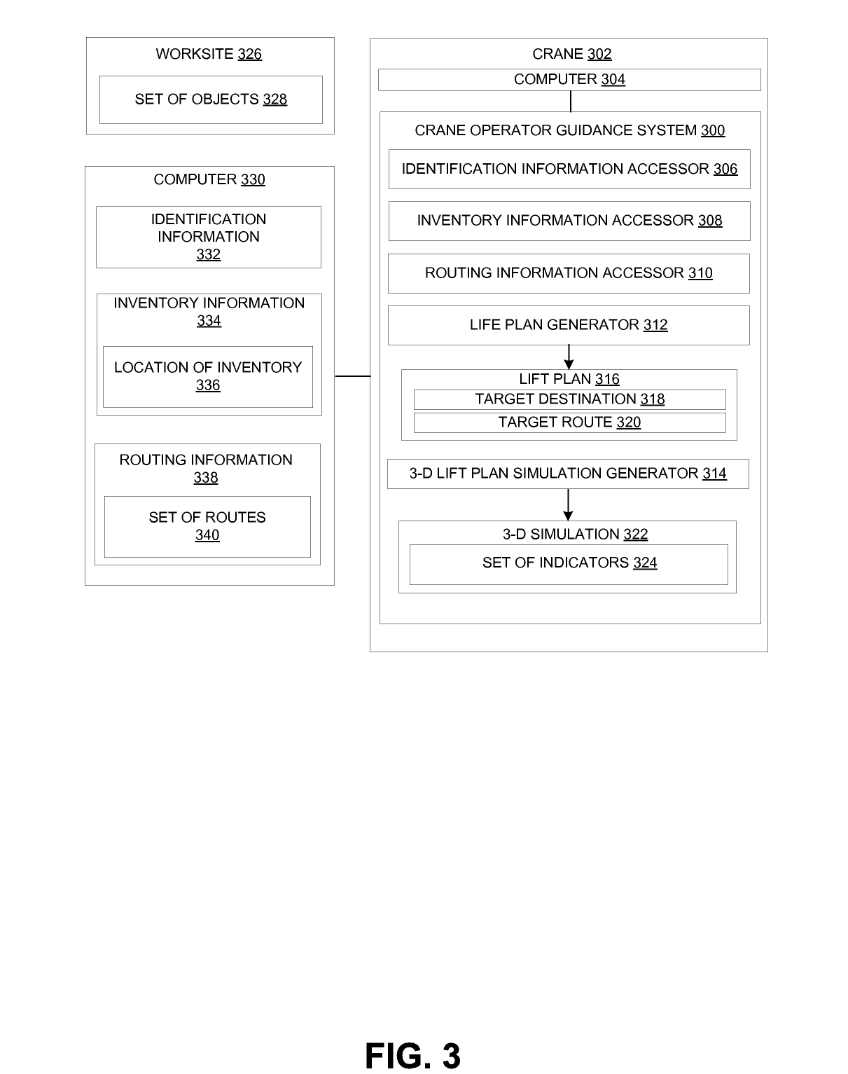

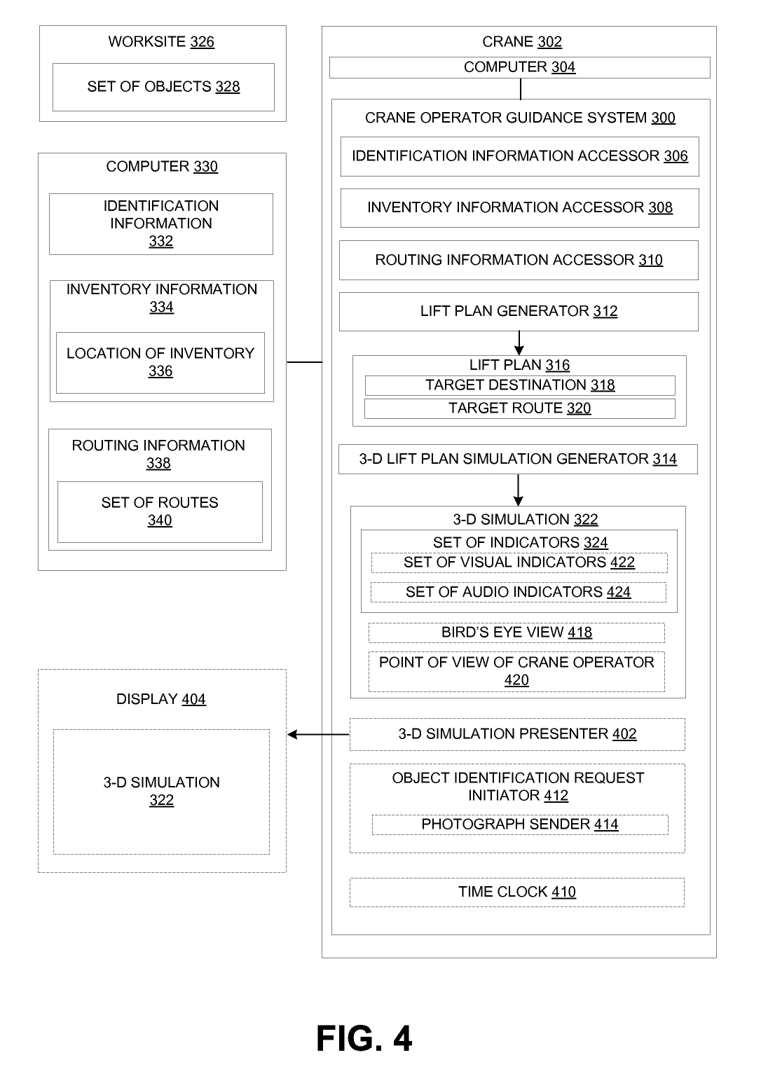

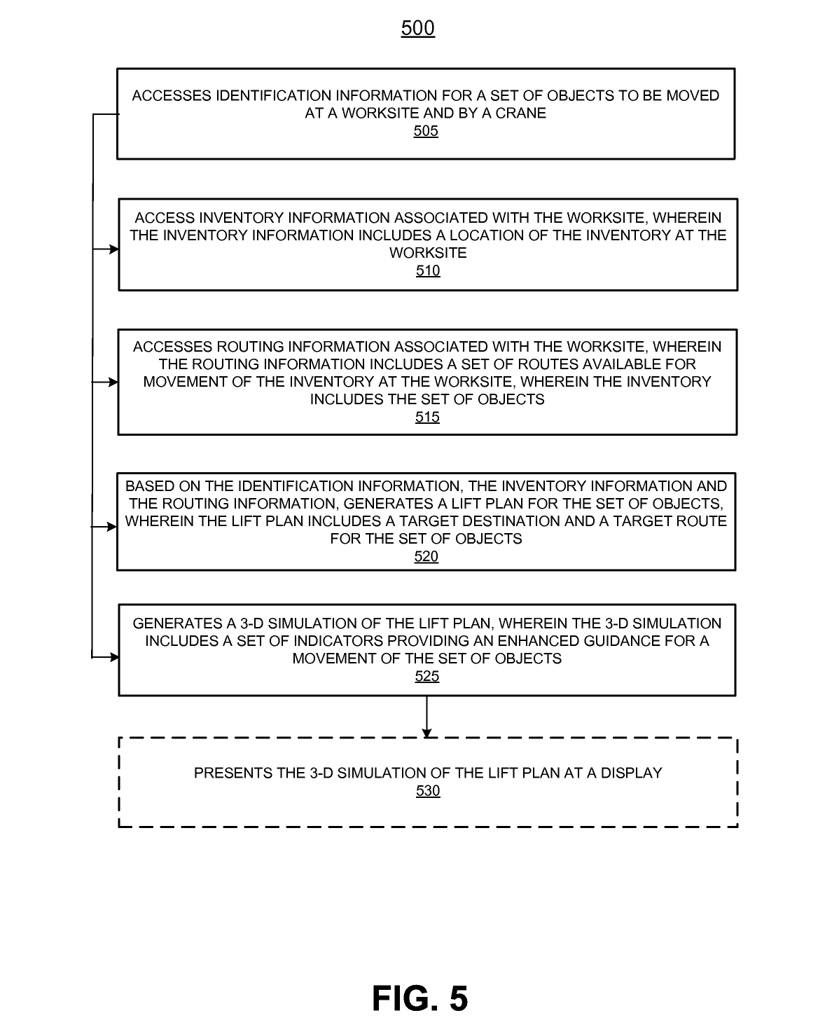

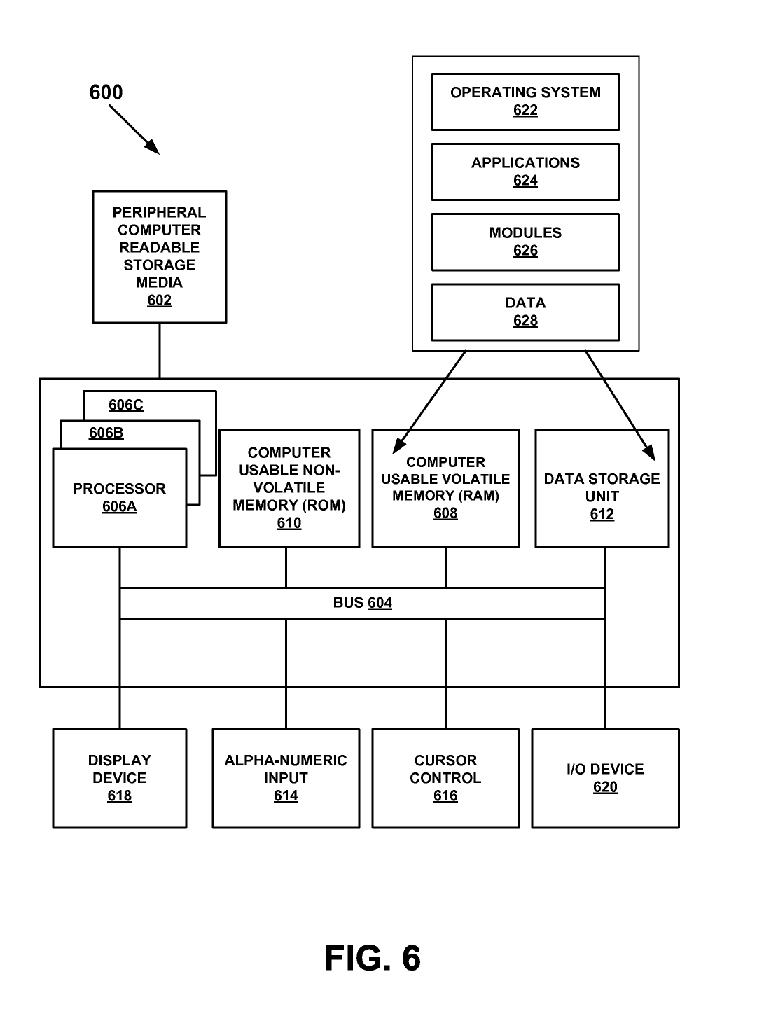

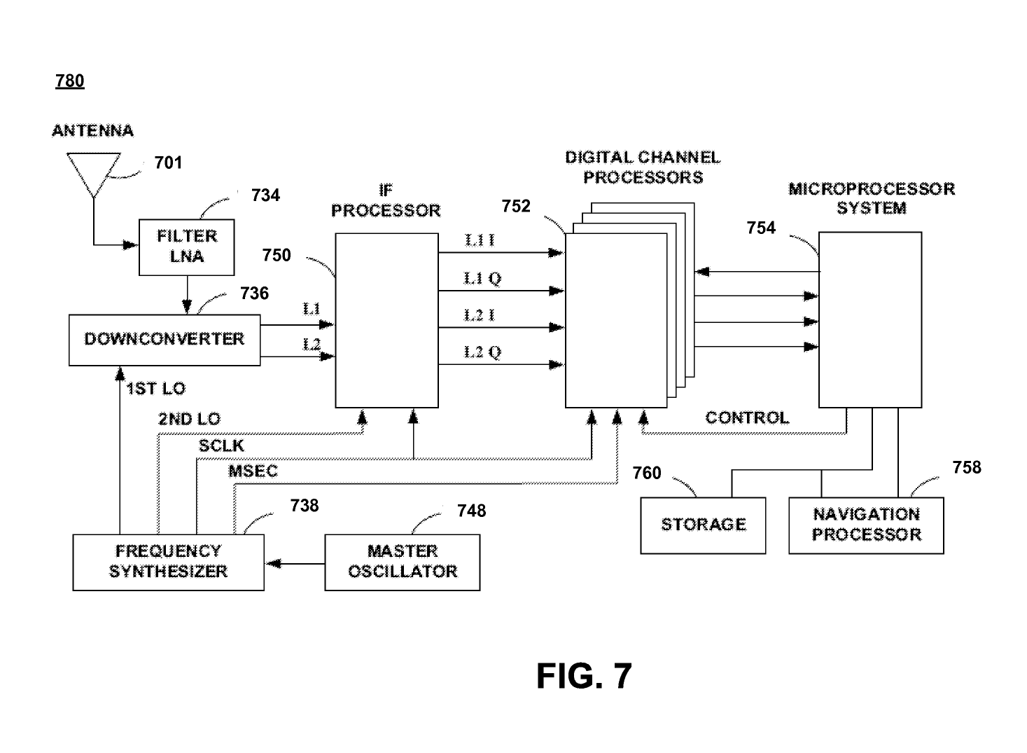

The discussion below begins with a general overview of embodiments. The discussion follows with a description of a tower crane system and a luffer crane (See FIGS. 1A and 1B) and an environment inclusive of a crane (See FIG. 2), in accordance with an embodiment. Following, a crane operator guidance system (See FIGS. 3 and 4) is described, in accordance with embodiments. A flowchart of a method for providing guidance to a crane operator (See FIG. 5) is shown, in accordance with embodiments. Then, an example computer system upon which embodiments of the present technology may be implemented (See FIG. 6) is described, and an example global navigation satellite system (GNSS) receiver which may be used in accordance with embodiments of the present technology (See FIG. 7) is described.

### General Overview of Embodiments

Cranes are large, tall machines used for moving heavy objects, typically by suspending them from a projecting arm or beam. Non-limiting examples of cranes are the tower crane and the luffer crane, as is shown in FIGS. 1A and 1B, as well as described herein. A crane operator is the person who maneuvering the crane to move objects. The crane operator faces many decisions while operating the crane. For example, the crane operator must decide which objects to move, to which location the objects are to be moved, and the pathway the crane should use to move the objects. Further, there are times when the crane operator causes the crane to move through worksite areas that are in fact blind to the crane operator. Thus, the crane operator is in need of assistance in making decisions regarding moving various objects.

Embodiments described herein provide a method and system for providing guidance to a crane operator for moving an object within a worksite. In one embodiment, a lift plan for a set of objects is generated based on the following: 1) the object's identity; 2) the inventory placement at the worksite; and 3) available routes to arrive at the target destination for the object. A worksite is the area in which the crane may be operated. A lift plan describes the target destination in the worksite for the object to be moved, and the available pathway(s) that the crane may/should take to arrive at the target destination in the most efficient manner.

In one embodiment, a 3-D simulation of the lift plan is generated and presented at a display screen for the crane operator's viewing. In various embodiments, the 3-D simulation of the lift plan is enabled to toggle between different perspectives, such as, but not limited to, the following: a bird's eye view; and a point of view of a crane operator. Further, in various embodiments, the 3-D simulation of the lift plan displays a set of indicators that provides to the crane operator an enhanced guidance for movement of the object. For example, the set of indicators includes, but is not limited to, any of the following: visual indicators (e.g., highlights of a target destination, text, instructions, providing arrows, blinking lights, etc.); and audio indicators (e.g., music, instructions, beeping sounds).

In one embodiment, a person (e.g., the crane operator, worksite manager, etc.) takes a photo of an object that is to be moved. In another embodiment, an RFID may be scanned by a rigger and sent to the crane operator, or scanned by the crane operator himself. In one embodiment, the photo and/or RFID is sent to a device/system for identifying an object. The device for identifying the object generates identification information such as, but not limited to the following identification information: name (make, model); weight; measurements; wholesale cost; retail cost; quantity in shipping container; total quantity at worksite; shipment date received; shipment date to be delivered; project to be used in; intended use in project; and alternative uses. In one embodiment, the identification information is accessed (retrieved and/or received).

In one embodiment, inventory information is accessed at a database of a computer. The computer may be located at the crane or external to the crane (e.g., worksite managing office, site external to the worksite, etc.). The inventory information includes, but is not limited to, the following information: the quantity of current inventory at the worksite; the location of current inventory at the worksite; inventory to be received in the future; any predefined areas at which inventory should be assigned; and the code number for each item of inventory. “Inventory” refers to merchandise or stock on hand, work in progress, raw materials, and finished goods on hand.

In one embodiment, routing information is accessed at a database of a computer. The computer may be located at the crane or external to the crane (e.g., worksite managing office, site external to the worksite, etc.). For example, routing information includes the current position of items at the worksite. The position of these items is determined through the use of sensors, cameras and global positioning systems placed through the worksite (including being placed on objects themselves). Additionally, the position of these items may be input into a computer, wherein the information is stored in a database at the computer. “[I]terms”, include, but are not limited to, the following things common to a worksite: inventory; containers holding the inventory; pathways between inventory; equipment; and buildings. The routing information includes a worksite layout, which includes a pathway(s) available between items and through which the crane may be driven.

The following is a high level general example of an implementation of an embodiment of the present technology. For instance, a crane operator is operating a tower crane at a construction worksite. The construction worksite includes: a partially built coffee house having a foundation laid and the structure framed; 24 sheets of stacked dry-wall; 420 stacked cinder blocks; 45 sheets of stacked plywood; and 15 crates of siding material. The worksite is expecting an inventory delivery of 5 stacked crates of roofing material in the late morning. In its periodic, but continuous, accessing of the inventory information, an embodiment discovers that the worksite is expecting an inventory delivery of 5 stacked crates of siding material. As will be explained below, an embodiment also periodically and continuously accesses the identification information for the object and the routing information. Based on the accessed inventory information, identification information and the routing information, an embodiment generates a lift plan for the roofing material, which describes where the roofing material should be placed at the worksite and the pathway which the crane should take in moving the roofing material to the target location. An embodiment then generates a 3-D simulation of the lift plan, which is then displayed to the crane operator. Additionally, the display to which the crane operator has access (e.g., personal computer, tablet, hand-held computer, cell phone, display attached to the crane) presents a set of indicators to the crane operator in the form of flashing red lights, a beeping sound, and the audible words, “New Lift”. Having been alerted to the lift plan, the crane operator then follows the lift plan instructions by moving the 15 crates of siding materials to a different location at the worksite, to be replaced by the incoming roofing material.

The following is a more in-depth description of the above general example. Embodiments access the inventory information, which includes: the location and quantity of the dry-wall, the cinder blocks, the plywood; the siding material at the worksite; the code number assigned to the dry-wall, the cinder blocks, the plywood and the siding material; and the quantity and code number assigned to the roofing material that is to be delivered to the worksite.

Embodiments also access the identification information for the roofing material that is to be delivered, including: make; model; weight per unit; weight per crate; dimensions of unit and crate; wholesale cost; retail cost; quantity to be shipped, total quantity already at worksite; shipment date to be delivered; time to be delivered; a description of the project for which the roofing material is to be used; the intended use within the project; and possible alternative uses for the roofing material, other than for the intended use within the project. All of the aforementioned identification information may help in determining where to place the object within the worksite. For example, since it is known that the roofing material will not be used until after the plywood is placed on the framed roof, based on the accessed information, embodiments may direct the crane operator to move the crates of roofing material to a location that is farther from the partially built coffee house than the plywood.

Embodiments also access the routing information for the roofing material, which includes the worksite layout for the coffee house construction site. For example, the worksite layout describes the location of each item at the worksite and the available pathways between and through the items and along which the crane operator may drive the crane. Once the elements of embodiments, such as the routing information, the identification information and the inventory information, are integrated such that a 3-D simulation of a lift plan may be presented on a display screen, the items at the worksite are represented by selectable icons (e.g., icons that resemble the items which are represented) which, upon selection (via a “click”, “tap” of the screen, voice command, etc.), provides more information at the display screen (audio and/or visual information regarding the icon “clicked”).

The lift plan for the delivered roofing material is presented to the crane operator at a display screen (e.g., a display screen within the crane's cab). The plan is 3-D and shows the recommended pathway for driving the crane to lift and move the siding material to a location at the outer edges of the worksite. The lift plan also presents the recommended pathway for driving the crane to lift and move delivered roofing material to the area cleared of siding material. As the lift plan accounts for the location of all items at the worksite, the crane operator need only look at the display screen to operate the crane such that the crane arrives at the target destination.

Thus, embodiments provide a 3-D lift plan to a crane operator, such that the crane operator may move an object via a crane at a worksite in the most efficient, cost-effective manner possible, while also safely navigating blind corners at the worksite during crane operations.

### General Description of Crane Operation

With reference now to FIG. 1A, an illustration of a side view of a tower crane 100 is presented, according to various embodiments. The tower crane 100 may also be referred to as a “horizontal crane”.

The tower crane 100 includes a base 104, a mast 102 and a working arm (e.g., jib) 110. The mast 102 may be fixed to the base 104 or may be rotatable about base 104. The base 104 may be bolted to a concrete pad that supports the crane or may be mounted to a moveable platform. In one embodiment, the operator 132 is located in a cab 106 which includes a user interface 137.

The tower crane 100 also includes a trolley 114 which is moveable back and forth on the working arm 110 between the cab 106 and the end of the working arm 110. A cable 116 couples a hook 122 and hook block 120 to trolley 114. A counterweight 108 is on the opposite side of the working arm 110 as the trolley 114 to balance the weight of the crane components and the object being lifted, referred to hereinafter as the object 118.

The tower crane 100 also includes location sensors 124, 126, 128, and 130 which are capable of determining the location of the tower crane 100, the pointing angle of the tower crane 100, or the location of a single component of the tower crane 100. The location sensors 124, 126, 128, and 130 may be employed to determine the location of the object 118 once it is loaded onto the tower crane 100 and the location of the object 118 after it is unloaded from the tower crane 100. It should be appreciated that the tower crane 100 may employ only one location sensor or any number of location sensors to determine a location and may employ more or less locations sensors than what is depicted by FIG. 1A. Alternatively, the location of the tower crane 100 may be stationary and known to a central computer system.

In one embodiment, location sensors 124, 126, 128, and 130 are GNSS receiver antennas each capable of receiving signals from one or more global positioning system (GPS) satellites and/or other positioning satellites, as is described in greater detail in reference to FIG. 7. Each of GNSS receiver antennas are connected to, coupled with, or otherwise in communication with a GNSS receiver. In one embodiment, the GNSS receiver (e.g., GNSS receiver 150-1) may be connected or coupled to the tower crane 100. For example, any of GNSS receiver antennas may also include a separate receiver. In one embodiment, the present technology makes use of only one GNSS receiver antenna and one GNSS receiver. In one embodiment, the present technology makes use of a plurality of GNSS receiver antennas in communication with only a single GNSS receiver (e.g., GNSS receiver 150-1 or 150-2). In one embodiment, the present technology makes use of a plurality of GNSS receiver antennas in communication with a plurality of GNSS receivers. In one embodiment, the GNSS receiver (e.g., GNSS receiver 150-2) is located remote to the tower crane 100 and is in communication with the GNSS receiver antenna/antennae on the crane via a coaxial cable and/or a wireless communication link.

It should be appreciated that the location sensors 124, 126, 128, and 130 may be other types of location sensors such as mechanical or optical. A mechanical or optical sensor may have electronic or digital components that are able to transmit or send location data to a central computer system. The mechanical sensors may operate to determine a swing arm location, angle, height, etc. The mechanical sensors may be used on any component of the crane including the swing arm, the trolley, the hook, etc.

In one embodiment, a single location sensor, such as the location sensor 128, is employed to determine a pointing angle of a crane. The single location sensor collects data from at least three positions as the tower crane pivots the arm. The three locations then form a circle with the pivot at the center. Once the pivot point is known, the pointing angle of the crane can be determined using the pivot point and the current location of the single location sensor. A second sensor may then be required to determine the height of the object that is lifted. The single location sensor may be GNSS antenna and the second sensor may be a mechanical sensor.

A GNSS receiver antenna may be disposed along a point of a boom assembly of the tower crane 100. The boom assembly may be comprised of the cab 106, the counterweight 108, the working arm 110, and the trolley 114.

As depicted in FIG. 1A, a location sensor, such as a GNSS receiver antenna/antennae, may be located at various points on the tower crane 100. The location sensor 124 is located on or part of the counterweight 108. The location sensor 126 is located on or part of the trolley 114. The location sensor 128 is depicted as located on or part of the working arm 110. The location sensor 130 is depicted as located on or part of the cab 106. A location sensor may also be located on or part of the pivot point of the tower crane 100. The hook block 120 and/or the hook 122 may also be coupled with a location sensor. It should be appreciated that GNSS antennae and receivers may have errors in determining exact geographic location. Such errors may be overcome using various techniques. The error may be described in statistical terms as an error ellipsoid. The error ellipsoid defines a three-dimensional region which is expected to contain the actual position of the antenna with a given level of confidence. When the distance between the pivot point and the GNSS receiver antenna are much greater than the size of the error ellipsoid, the error in determining the actual pointing angle of the working arm of the crane is reduced.

In one embodiment, the present technology may determine locations in a local coordinate system unique to the construction site or environment. In one embodiment, the present technology may determine locations in an absolute coordinate system that applies to the whole Earth such as the coordinate system used by the Genesis system. The locations may be determined at the location sensors such as the GNSS receiver, or the location sensors may just send raw data to the central computer system where the location is determined based on the raw data.

In one embodiment, the sensor 182 is a load sensor that is able to detect that the tower crane 100 has picked up a load such as the object 118. The sensor 182 is depicted as being coupled with or located on the hook block 120. However, the sensor 182 may be located on another part or component of the tower crane 100 such as the hook 122 or the trolley 114. In one embodiment, the sensor 182 is an ID sensor configured to automatically identify the object 118. For example, the object 118 may have an RFID chip and the sensor 182 is an RFID detector or reader that can receive data from the RFID chip used to identify what type of object or material the object 118 is. The data on the RFID chip may have data such as a model number, a serial number, a product name, characteristics of the product such as weight and dimensional, installation information, technical specifications, date of manufacture, point of origin, manufacturer name, etc. The RFID chip may also contain data that points the sensor 182 to a database that comprises more data about the object 118. In one embodiment, the sensor 182 will not identify the object 118 until it has feedback that the object 118 has been loaded onto the tower crane 100. In one embodiment, the load sensor triggers the locations sensors of the tower crane 100 to send location data to the central computer system at the time the object is loaded on the crane and/or at the time the object is unloaded from the crane.

It should be appreciated that the various sensors of the tower crane 100 such as location sensors, load sensors, or ID sensors may transmit or send data directly to a central computer system or may send data to a computer system coupled with and associated with the tower crane 100 which then relays the data to the central computer system. Such transmissions may be sent over data cables or wireless connections such as Wifi, Near Field Communication (NFC), Bluetooth, cellular networks, etc.

With reference now to FIG. 1B, an illustration of a side view of the crane 160 is presented, according to various embodiments. The crane 160 may also be referred to as a luffer crane or a level luffing crane. The crane 160 may comprise some of the components described for the tower crane 100 of FIG. 1A.

The base 161 is a base or housing for components of the crane 160 such as motors, electrical components, hydraulics, etc. In one embodiment, the structure 162 comprises wheels, tracks, or other mechanics that allow for the mobility of the crane 160. In one embodiment, the structure 162 comprises outriggers that can extend or retract and are used for the stability of the crane 160. In one embodiment, the structure 162 is a platform for a stationary crane. It should be appreciated that the base 161 is able to rotate, swivel, or pivot relative to the structure 162 along the axis 167. The location sensor 163 may be disposed on top of the base 161 or may be disposed inside of the base 161. The location sensor 163 will move and rotate with the base 161 about the axis 167.

The pivot point 164 allows for the lattice boom 165 to pivot with respect to the base 161. In this manner, the lattice boom 165 can point in different directions and change the angle of the pivot point 166. The pivot point 166 allows for the jib 168 to pivot and change position with respect to the lattice boom 165 and the base 161. A location sensor may be attached to or coupled with any component of the crane 160. For example, the pivot points 164 and 166 may have a GNSS receiver antenna coupled to them. The location sensors 130, 163, 169, 170, and 171 depict various locations a location sensor may be located.

It should also be appreciated that the present technology may be implemented with a variety of cranes including, but not limited to, a tower crane, a luffing crane, a level luffing crane, a fixed crane, a mobile crane, a self-erecting crane, a crawler crane, and a telescopic crane.

With reference now to FIG. 2, an illustration of an environment 200, is shown in accordance with embodiments of the present technology. The environment 200 depicts a crane 205 which comprises the features and components of the cranes described in FIGS. 1A and 1B. It should be appreciated that the crane 205 may comprise location sensors, load sensors, and/or ID sensors. The environment 200 may be a construction site, job site or other environment where large and heavy objects are lifted and moved by lifting devices such as the crane 205. The crane 205 is capable of moving objects such as objects 215, 220, 225, and 230, in at least the following directions: side-to-side, up and down, forward and backwards. The objects 215, 220, 225, and 230 may be building material or equipment used in the construction of the structure 210. The structure 210 may be a building such as a sky scraper, office tower, house, bridge, overpass, road, etc. The objects 220 and 225 are depicted as being in a staging area where they have been delivered to be used in the construction environment. The object 215 is depicted as being lifted by the crane 205. The object 230 is depicted as being delivered by the crane 205 from the staging area to the structure 210. The object 230 may already be installed in the structure 210 or may be waiting to be installed in the structure 210. The objects 215, 220, 225, and 230 may be different types of building materials or may be the same type.

In one embodiment, the objects 215, 220, 225, and 230 are each coupled with or otherwise associated with identifiers 216, 221, 226, and 231 respectively. The identifiers 216, 221, 226, and 231 comprise information or data about the identity and characteristics of their respective objects. The data on the identifier may identify the object. This data may simply be written or inscribed on the object or a label or may be stored on an RFID chip or may be coded using bar code, quick response (QR) code, or other code. The identifier may contain the data itself or may point a user or device to a database where the data is stored. The data, or other data, may include a model number, serial number, product name, characteristics of the product such as size, shape, weight, center of gravity, rigging or equipment needed to lift the object, where the object needs to be moved to on the job site, and other characteristics that may assist a crane operator or job site manager in planning and executing the lift of the identified object, installation information, technical specifications, date of manufacture, point of origin, manufacturer name, etc.

The environment 200 depicts a rigger 240. The rigger 240 is a person associated with the job site who typically works closely with the operator of the crane 205. However, the rigger 240 as depicted in the environment 200 may represent any person or user associated with the present technology. The rigger 240 may be responsible for ensuring that an object is properly loaded or rigged for loading onto the crane 205 for lifting. The rigger 240 is depicted as carrying a handheld device 245 which is an electronic device capable of sending electronic data to the central computer system 235. In one embodiment, the handheld device 245 is a mobile computer system, a smart phone, a tablet computer, or other mobile device. The handheld device 245 may have output means such as a display and/speakers and input means such as a keyboard, touchscreen, microphone, RFID reader, camera, bar code scanner, etc. The handheld device 245 may comprise a battery for power and may send data over a wireless connection such as Wifi, Near Field Communication (NFC), Bluetooth, cellular networks, etc. The handheld device 245 may be an off-the-shelf device that may have components added to it or may be a specific purpose device built for the present technology.

The handheld device 245 may also comprise communication components that allow the rigger 240 to communicate verbally or otherwise with the operator of the crane 205 as well as other personnel such as a job foreman. In one embodiment, the handheld device 245 displays a lift plan to rigger 240 that is a schedule of what objects are to be lifted by crane 205 and in what order. Thus, the rigger 240 knows what object is to be loaded or lifted next. For example, after the object 215 is lifted, then the lift plan may inform the rigger 240 that the object 220 is to be lifted next. The rigger 240 can then identify and prepare or rig the object 220 for lifting. The handheld device 245 may assist the rigger 240 in identifying the object 220 by the handheld device 245 scanning, detecting, or otherwise reading the identifier 221. After an object is identified, the identification data may be sent to the operator of crane 205, the job foreman, the central computer system 235, and/or other places, such as the crane operator guidance system 300 (See FIG. 3) of the present technology (discussed in detail below). In one embodiment, the crane operator guidance system 300 is located at the central computer system 235. In another embodiment, the crane operator guidance system 300 is located at the crane 302. In one embodiment, the crane operator guidance system 300 is located external to, communicatively coupled with, the central computer system 235. In one embodiment, after the object is identified by the rigger 240, the handheld device 245 may give the rigger 240 the opportunity to modify, verify, update, supplement, or otherwise change the identification data. Other personal may also be given the opportunity to change the data such as the operator of the crane 205 or the job foreman. The identification data may also comprise the other data regarding the characteristics of the object. In one embodiment, the rigger 240 manually enters data regarding the identity or characteristics of the object into the handheld device 245 based on data that the rigger 240 reads from a label applied to the object or based on a visual identification on the part of the rigger. The sensors associated with handheld device 245 that identify an object may be referred to as identity sensors.

In one embodiment, the handheld device 245 may be in communication with the load sensor of the crane 205 such that the identification data is not sent to crane operator guidance system 300 and/or to the central computer system 235 until the object 220 is loaded onto the crane at which point the identification data is sent automatically. This loading may also trigger location data to be sent to the crane operator guidance system 300 and/or the central computer system 235 simultaneously. In one embodiment, the handheld device 245 requires the rigger to authorize the identification information being sent to the crane operator guidance system 300 and/or the central computer system 235 such that the rigger 240 may verify that the object has actually been lifted by the crane 205.

The central computer system 235, either directly or indirectly through the crane operator guidance system 300, receives location data, load data, sensor data, identification data, etc., from the sensors associated with crane 205 and the data from the handheld device 245. The central computer system 235 is then able to track the objects for inventory purposes and other job planning purposes and/or is able to create a record for what was done at the environment 200. The record may be an installation record. In one embodiment, based on the tracking of an object, the central computer system 235 may determine that the object being lifted is being lifted out of sequence in accordance with a lift plan for crane 205 and environment 200. The central computer system 235 may then be able create an updated lift plan and send it to the crane operator, the rigger 240 and the job foreman. Once the object has been identified and a sequence of events determined, the central computer system 235 may also be able to provide additional information to the rigger, the crane operator and the job foreman to formulate a strategy for lifting the object. The central computer system 235 may receive a plurality of locations and timeline information for a single object including a first location where the object was initially lifted at a certain time by crane 205 and a second location where the object was unloaded at a certain time by the crane. The central computer system 235 may receive location data from location sensors that are not located directly on the object. However, the central computer system 235 may be able to infer the actual location of the object based on the knowledge of where the location sensor is located on the crane and where the object is lifted by the crane. For example, the central computer system 235 may receive location data from a location sensor located on a trolley of the crane 205 as well as height data from the pulley system used to lift the object via the hook on the crane 205. The combination of this data is then used to infer exactly where the object is located even though the object does not have a location sensor on it. In one embodiment, the location data is received from a lifting device at the central computer system. In one embodiment, the lifting device is a crane, as depicted in FIGS. 1A, 1B, and 2, or a forklift. The location data may be from a location sensor associated with the lifting device and may be a GNSS sensor, a mechanical sensor, or other sensor. The location of the lifting device may be fixed and known to the central computer system. The location data may be in the context of a local coordinate system or an absolute coordinate system.

It should be appreciated that the central computer system 235 maybe located at the environment 200 or located anywhere else in the world. The central computer system 235 may be more than one computer system and may have some components located in the environment 200 and others located elsewhere. In one embodiment, the central computer system 235 is a crane operator guidance system 300. In one embodiment, the central computer system 235 is associated with a crane operator guidance system 300 and is able to pull information from the crane operator guidance system 300.

It should be appreciated that while FIGS. 1A, 1B, and 2 depict cranes, the present technology may also be practiced using other lifting devices such as forklifts. In accordance with the present technology, a forklift would have location sensors to generate location information about an object and possibly load sensors to generate data regarding when the object was loaded and unloaded from the forklift and possibly ID sensors to identify the object being loaded. The forklift may also be used in conjunction with a rigger and a handheld device.

### Example Crane Operator Guidance System

FIGS. 3 and 4 show block diagrams of an example crane operator guidance system 300, in accordance with an embodiment. The crane operator guidance system 300 includes the following components coupled with a computer 304 (See example computer 600 of FIG. 6—computer 304 includes similar features as computer 600): an identification information accessor 306; an inventory information accessor 308; a routing information accessor 310; a lift plan generator 312; and a 3-D lift plan simulation generator 314. In various optional embodiments, the crane operator guidance system 300 includes any of the following: a 3-D simulation presenter 402; a time clock 410; an objection identification request initiator 412 that optionally includes a photograph sender 414; and a target efficiency objective model generator 416.

In one embodiment, the crane operator guidance system 300 is located at the crane 302. In another embodiment, the crane operator guidance system 300 is located external to but is communicatively coupled with (via wire and/or wirelessly) the crane 302. In one embodiment, the crane operator guidance system 300 is communicatively coupled with, via wire and/or wirelessly, the computer 304. In one embodiment, the computer 304 is located at the crane 302. In another embodiment, the computer 304 is located external to but is communicatively coupled with (via wire and/or wirelessly) the crane 302.

In various embodiments, the computer 330 includes any of the following: the identification information 332; the inventory information 334; and the routing information 338. In various embodiments, at least one of the following is located at a computer communicatively coupled with, via wire and/or wirelessly, the computer 330 and/or is communicatively coupled with, via wire and/or wirelessly, the computer 304 and/or is communicatively coupled with via wire and/or wirelessly the crane operator guidance system 300.

Further, in one embodiment, the computer 330, in one embodiment, is located external to but is communicatively coupled with, via wire and/or wirelessly, the crane operator guidance system 300. In another embodiment, the computer 330 is located at the crane 302, is external to and communicatively coupled with, via wire and/or wirelessly, the crane operator guidance system 300. In yet another embodiment, the computer 330 is the same as computer 304. In another embodiment, the crane operator guidance system 300 includes the computer 330.

Thus, it should be appreciated that the method and system for providing guidance to a crane operator, in various embodiments, is implemented through what may be a network of computers (e.g., computer 304, computer 330, and other computers housing together or separately the identification information 332, the inventory information 334 and the routing information 338) located at the crane 302 and/or external to the crane 302.

The identification information accessor 306 accesses identification information 332 for the set of objects 328 to be moved at a worksite 326 and by a crane 302. It should be appreciated that the set of objects 328 includes one or more objects 328. In one embodiment, the set of objects 328 is the object 230 of FIG. 2. In one embodiment, the identification information 332 is located at the computer 330. In one embodiment, the set of objects 328 have embedded therein a RFID. In one embodiment, a rigger and/or the crane operator scans the RFID with a hand-held device capable of scanning the RFID, and sends data retrieved from the RFID scan to a device capable of identifying an object using such data. In one embodiment, the device capable of identifying an object using such data is located at computer 330 or is communicatively coupled with, via wire and/or wirelessly, the computer 330. In one embodiment, the device includes a store of object identification information with which the data retrieved from the RFID scan is compared. Once a match (the RFID scan identification and the identification in the store of object identification information is the same) is found, the object identification information that is associated with the match is also determined. The identification information accessor 306, in one embodiment, then accesses the identification information 332.

In one embodiment, the crane operator guidance system 300 includes the object identification request initiator 412, which optionally includes the photograph sender 414. The object identification request initiator 412 initiates a request for an object identification by sending a photograph of the set of objects 328 to a device that is configured for providing the identification information 332. For example, the crane operator may take a photo of pile of gravel. The crane operator then transmits, through techniques known in the art, to a device that is configured for providing identification information based on images found within the photo. The device compares the image sent in the photo with a database of images and/or other information for identifying objects. The sending of the photo to the device is itself a request for an object identification to be performed by the device configured for performing object identifications. The identification information accessor 306 may then access the identification information 332 determined by the object identifier device.

The inventory information accessor 308 accesses inventory information 334 associated with the worksite 326, wherein the inventory information 334 includes a location of the inventory at the worksite 326, wherein the inventory includes the set of objects 328. In one embodiment, the inventory information 334 is located at the computer 330.

The routing information accessor 310 accessing routing information 338 associated with the worksite 326, wherein the routing information 338 includes a set of routes 340 that are available for the movement of the set of objects 328 at the worksite. It should be appreciated that the set of routes 340 refers to one or more routes. In one embodiment, the routing information accessor 310 is located at the computer 330.

The lift plan generator 312 generates a lift plan 316 for the set of objects 328, based on the identification information 332, the inventory information 334 and the routing information 338. The lift plan 326 includes a target destination 318 and a target route 320 for the set of objects 328. The target destination 318 is the location at which the crane operator guidance system 300 has determined is the best location to place the set of objects 328, based upon an analysis of preprogrammed variables associated with the set of objects 328, the inventory and the routing information. The target route 320 is the pathway that the crane operator guidance system 300 has determined is the best pathway for the crane 302 to follow in moving the set of objects 328 to the target destination 318. The target route 320 is determined according to an analysis of preprogrammed variables that are associated with the set of objects 328 and are analyzed in conjunction with the accessed identification information 332, the inventory information 334 and the routing information 338. Preprogrammed variables may be, but are not limited to being, any of the following: construction project phases; materials needed for each construction project phase; time estimates for each construction project phase; time estimates for subsets of each construction project phase; costs associated with construction project phases; worksite dimensions, including all items within the worksite; a projected and/or desired timeline for construction project phases and each subset thereof; workers at the worksite; the pay structure for the workers at the worksite; and a consideration of the work calendar, including employee holidays and worker schedules. Thus, the crane operator guidance system 300 accesses the identification information 332, the inventory information 334 and the routing information 338, and generates, according to preprogrammed instructions, the lift plan 316.

The 3-D lift plan simulation generator 314 generates a 3-D simulation 322 of the lift plan 316, wherein the 3-D simulation 322 includes a set of indicators 324 that provide an enhanced guidance for the movement of the set of objects 328. It should be appreciated that the set of indicators 324 includes one or more indicators.

In one embodiment, the set of indicators 324 is a set of visual indicators 422. It should be appreciated that the set of visual indicators 422 may be one or more visual indicators. A visual indicators may be, but is not limited to being, any of the following: highlight of a target destination; a text communication that is personal to the crane operator (customized text that takes into account the crane operator's personal traits and/or style of communication [e.g., “How's it going Bob?”, “How are you doing today, Robert?”] or gives a personal address to the crane operator [e.g., “Hello, Bob.” vs. “Hello.”]); a text communication that is non-personal to the crane operator (that is not customized); instructions; arrows, flashing components on the screen (e.g., flashing arrows); items of varying colors on the display screen, etc. In one example, the display shows, within the 3-D simulation 322, arrows that indicate to that the crane 302 certain movements, such as, “go left” (arrow pointing left), “move up” (arrow pointing up), “move north” (arrow pointing in the north direction), etc.

In another embodiment, the set of indicators 324 is a set of audio indicators 424. It should be appreciated that that set of audio indicators 424 may be one or more audio indicator. The set of audio indicators 424 may be, but is not limited to being, any of the following: audible words; audible music; audible beeping; audible ringing; audible animal noises; audible sound effects, etc. For example, recorded words may be played back that indicate which direction the crane 302 should be driven, such as the words: go left” (arrow pointing left); “move up” (arrow pointing up); “move north” (arrow pointing in the north direction), etc. Further, in one embodiment, audible sounds are played over speakers situated at the crane 302. In another embodiment, the speakers are situated at the worksite and within hearing distance of the crane operator.

In one embodiment, the set of indicators 324 includes both a set of visual indicators 422 as described herein and a set of audio indicators 424 as described herein.

In one embodiment, the crane operator guidance system 300 further includes a 3-D simulation presenter 402. The 3-D simulation presenter 402 presents the 3-D simulation 322 of the lift plan 316 at the display 404. It should be appreciated that the display 404 may be, but is not limited to being, any of the following types of displays: a display located on the crane 302; a display located at a device being hand-held by the crane operator; a display remote from the crane and viewable by the crane operator, wherein the crane operator is remotely operating the crane 302; and a display remote from the crane and viewable by a third party who is not the crane operator but who has the capability of communicating with the crane operator such that the crane operator may follow the instructions provided by the 3-D simulation 322.

In one embodiment, the crane operator guidance system 300 includes a time clock 410. The time clock 410 sends an activation signal, when a predefined time has expired, to the identification information accessor 306, the inventory information accessor 308 and/or the routing information accessor 310, wherein the activation signal prompts the identification information accessor 306, the inventory information accessor 308 and/or the routing information accessor 310 to perform the accessing of identification information 332, inventory information 334 and routing information 338, respectively, and as described herein.

In one embodiment, the crane operator guidance system 300 includes the target efficiency objective model generator 416. The target efficiency objective model generator 416 generates a lift plan that includes at least a most efficient method for moving the set of objects 328 to the target destination 318 along the target route 320, wherein the generating of the lift plan is based on at least the identification information 332, the inventory information 336 and the routing information 338.

In one embodiment, the most efficient method refers to the fastest time that the set of objects 328 can be moved to the target destination 318.

In another embodiment, the most efficient method refers to the fastest time that a portion of a project at a worksite can be completed, wherein the completion of the portion of the project includes moving the set of objects 329 to the target destination 318. For example, suppose that time “A” represents the estimated elapsed time that is anticipated to occur in moving a set of objects “Y” from point “N” to a target destination “N” taking a pathway “P”. Further, suppose that time “B” represents the estimated elapsed time that is anticipated to occur in moving the set of objects “Y” from point “N” to the target destination “N” taking a pathway “Q”. In this example, time “A” is 15 minutes, while time “B” is 20 minutes. However, based on a larger perspective, such as analyzing the whole construction project or a portion thereof that is bigger, including more project phases (a project phase refers to an event or set of events occurring during the project), than the singular event of moving the set of objects “Y” from point “N” to the target destination “N”, the target efficiency objective model generator 416 determines that in fact the pathway “Q” associated with time “B” of 20 minutes enables the project phase to move more quickly. This may occur if by moving along pathway “Q” instead of pathway “P”, other cranes in operation are not impeded in their progress. Thus, the lift plan would include a recommended movement along pathway “Q” to move the set of objects to the target destination “N”. Thus, it can be seen that the target efficiency objective model generator 416 takes into account the identification information 332, the inventory information 334, the routing information 338, as well as the totality of the environment itself, wherein the environment may include construction project phases (if the worksite is a construction worksite), and/or inventory movement (if the worksite is a warehouse, store, landscaping yard, etc.).

### Example Method for Providing Guidance to a Crane Operator

With reference to FIG. 5, the process 500 is a process for providing guidance to a crane operator, according to an embodiment. In one embodiment, the process 500 is a computer implemented method that is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of non-transitory computer readable storage medium. In one embodiment, the process 500 is performed by components of FIGS. 1A, 1B, 2, 3 and 4. In one embodiment, the methods may reside in a computer readable storage medium having instructions embodied therein that when executed cause a computer system to perform the method.

At step 505, in one embodiment and as described herein, identification information 332 for a set of objects 328 to be moved at a worksite 326 and by a crane 302 is accessed. In one embodiment and as described herein, the accessing of the identification information 332 performed at step 505 occurs at a predefined periodic interval. For example, in one embodiment, the predefined periodic interval may be every two minutes. Thus, every two minutes, the identification information 332 will be accessed. In another embodiment and as described herein, the accessing of the identification information at step 505 occurs after an initiation of an object identification request. In yet another embodiment, and in furtherance to step 505 in which the accessing of the identification information 332 occurs after an initiation of an object identification request, the object identification request is initiated by sending a photograph of a set of objects 328 to a device that is configured for providing the identification information 332. In yet another embodiment, a rigger may use a hand-held device to read the RFID tags embedded within a set of objects, and then send the information that is read to the device that is configured for providing the identification information 332. In one embodiment the identification information 332 is accessed at step 505 after the accessed inventory information 334 indicates that a delivery of inventory is to be made to the worksite 326. For example, in one embodiment, after it is determined (step 510) that the inventory “S” is to be delivered to the worksite 326 at a time in the future, the identification information 332 for inventory “S” is accessed.

At step 510, in one embodiment and as described herein, inventory information 334 associated with the worksite 326 is accessed, wherein the inventory information 334 includes a location of inventory at the worksite 326. In one embodiment and as described herein, the accessing of the inventory information 334 occurs at a predefined periodic interval. For example, in one embodiment, the predefined periodic interval may be every minute. Thus, every minute, the inventory information 334 will be accessed.

At step 515, in one embodiment and as described herein, the routing information 338 associated with the worksite 326 is accessed, wherein the routing information 338 includes a set of routes 340 that are available for movement of the inventory at the worksite 326. By “available”, it is meant that a crane 302 is physically able to maneuver through the route. In one embodiment and as described herein, the accessing of the routing information 338 that occurs at step 515 occurs at a predefined periodic interval. For example, in one embodiment, the predefined periodic interval is every thirty seconds. Thus, every thirty seconds, the routing information 338 is accessed. Therefore, embodiments track the location of items at a worksite, and are consequently able to determine if items are blocking previously unimpeded pathways. In one embodiment, the routing information 338 is accessed at step 515 after the accessed inventory information 334 indicates that a delivery of inventory is to be made to the worksite 326. For example, in one embodiment, after it is determined (step 510) that the inventory “T” is to be delivered to the worksite 326 at a time in the future, the identification information 332 for inventory “T” is accessed.

At step 520, in one embodiment and as described herein, a lift plan 316 is generated, wherein the lift plan 316 includes the target destination 318 and the target route 320 for the set of objects 328. The generating of the lift plan 316 is based on the identification information 332, the inventory information 334 and the routing information 338. In one embodiment and as described herein, the lift plan 316 that is generated at step 520 includes at least the most efficient method for moving the se of objects 328 to the target destination 318 along the target rout 320, wherein such most efficient method is based on at least the identification information 332, the inventory information 334 and the routing information 338.

At step 525, in one embodiment and as described herein, a 3-D simulation 322 of the lift plan 316 is generated, wherein the 3-D simulation 322 includes a set of indicators 324 that provide an enhanced guidance for a movement of the set of objects 328. In one embodiment, the 3-D simulation 322 of the lift plan 316 is generated from the point of view of the crane operator. In other words, when the crane operator looks at the 3-D simulation 322 as it is displayed on the display 404, the 3-D scene of the worksite 326 is displayed on the display 404 to portray the items within the worksite 326 from the angle of the eyes of the crane operator as the crane operator is sitting in the crane 304. In another embodiment, the 3-D simulation 322 of the lift plan 316 is generated from a bird's eye view. In other words, when the crane operator looks at the 3-D simulation 322 as it is displayed on the display 404, the 3-D scene of the worksite 326 is displayed on the display 404 to portray the items within the worksite 326 from the angle of the eyes of a bird flying overhead the worksite items. Thus, the crane operator will, for the most part, be looking down on the items as he is looking at the 3-D simulation on the display screen. In an embodiments, the crane operator may toggle between different perspectives of the worksite, via, but not limited to, one or more of the following techniques: tapping on an icon on a touchscreen causing a toggle between perspectives; flipping a switch; turning a dial; and giving an audio instruction to cause a toggle between perspectives. By “enhanced guidance” to the lift plan 316, it is meant that specific areas of the display 404 showing the 3-D simulation 322 are manipulated to stand out to the viewer.

At step 530, in one embodiment and as described herein, the 3-D simulation 322 of the lift plan 316 is presented at the display 404. In one embodiment, the 3-D simulation 322 of the lift plan 316 is interactive, in that areas of the display representing various items within the worksite 326 may be touched to access information about the items, such as, but not limited to, the following: identification information 332 if any; inventory information 334 if any; routing information 338 if any; status as mobile or immobile; temporary or permanent structure; relationship with other items; and relationship with inventory. Thus, in one example, by tapping on a 3-D image of an item on the display 404 that is a touch screen, the viewer is able to access more information about the item. In various additional embodiments, upon tapping on the 3-D image of the item on the display 404 that is a touch screen, information is presented in lieu of the item's image, information is presented in conjunction with the item's image as well as other item images on the display 404, or information is presented in conjunction with an enlarged image of the item.

### Computer System

With reference now to FIG. 6, portions of the technology for providing a communication composed of computer readable and computer executable instructions that reside, for example, in non-transitory computer readable storage media of a computer system. That is, FIG. 6 illustrates one example of a type of computer that can be used to implement embodiments of the present technology, such as the handheld device 245, central computer system 235 of FIG. 2 and the crane operator guidance system 300 of FIGS. 3 and 4. FIG. 6 represents a system or components that may be used in conjunction with aspects of the present technology. In one embodiment, some or all of the components of FIGS. 1A, 1B, 2, 3 and 4 may be combined with some or all of the components of FIG. 6 to practice the present technology.

FIG. 6 illustrates an example computer system 600 used in accordance with embodiments of the present technology. It is appreciated that system 600 of FIG. 6 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 6, computer system 600 of FIG. 6 is well adapted to having peripheral computer readable media 602 such as, for example, a floppy disk, a compact disc, and the like coupled thereto.

System 600 of FIG. 6 includes an address/data bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors. System 600 also includes data storage features such as a computer usable volatile memory 608, e.g. random access memory (RAM), coupled to bus 604 for storing information and instructions for processors 606A, 606B, and 606C.

System 600 also includes computer usable non-volatile memory 610, e.g. read only memory (ROM), coupled to bus 604 for storing static information and instructions for processors 606A, 606B, and 606C. Also present in system 600 is a data storage unit 612 (e.g., a magnetic or optical disk and disk drive) coupled to bus 604 for storing information and instructions. System 600 also includes an optional alpha-numeric input device 614 including alphanumeric and function keys coupled to bus 604 for communicating information and command selections to processor 606A or processors 606A, 606B, and 606C. System 600 also includes an optional cursor control device 616 coupled to bus 604 for communicating user input information and command selections to processor 606A or processors 606A, 606B, and 606C. System 600 of the present embodiment also includes an optional display device 618 coupled to bus 604 for displaying information.

Referring still to FIG. 6, optional display device 618 of FIG. 6 may be a liquid crystal device, cathode ray tube, plasma display device, light emitting diode (LED) light-bar, or other display device suitable for creating graphic images and alpha-numeric characters recognizable to a user. Optional cursor control device 616 allows the computer user to dynamically signal the movement of a visible symbol (cursor) on a display screen of display device 618. Many implementations of cursor control device 616 are known in the art including a trackball, mouse, touch pad, joystick or special keys on alpha-numeric input device 614 capable of signaling movement of a given direction or manner of displacement. Alternatively, it will be appreciated that a cursor can be directed and/or activated via input from alpha-numeric input device 614 using special keys and key sequence commands.

System 600 is also well suited to having a cursor directed by other means such as, for example, voice commands. System 600 also includes an I/O device 620 for coupling system 600 with external entities. For example, in one embodiment, I/O device 620 is a modem for enabling wired or wireless communications between system 600 and an external network such as, but not limited to, the Internet. A more detailed discussion of the present technology is found below.

Referring still to FIG. 6, various other components are depicted for system 600. Specifically, when present, an operating system 622, applications 624, modules 626, and data 628 are shown as typically residing in one or some combination of computer usable volatile memory 608, e.g. random access memory (RAM), and data storage unit 612. However, it is appreciated that in some embodiments, operating system 622 may be stored in other locations such as on a network or on a flash drive; and that further, operating system 622 may be accessed from a remote location via, for example, a coupling to the internet. In one embodiment, the present technology, for example, is stored as an application 624 or module 626 in memory locations within RAM 608 and memory areas within data storage unit 612. The present technology may be applied to one or more elements of described system 600.

System 600 also includes one or more signal generating and receiving device(s) 630 coupled with bus 604 for enabling system 600 to interface with other electronic devices and computer systems. Signal generating and receiving device(s) 630 of the present embodiment may include wired serial adaptors, modems, and network adaptors, wireless modems, and wireless network adaptors, and other such communication technology. The signal generating and receiving device(s) 630 may work in conjunction with one or more communication interface(s) 632 for coupling information to and/or from system 600. Communication interface 632 may include a serial port, parallel port, Universal Serial Bus (USB), Ethernet port, antenna, or other input/output interface. Communication interface 632 may physically, electrically, optically, or wirelessly (e.g. via radio frequency) couple system 600 with another device, such as a cellular telephone, radio, or computer system.

The computing system 600 is only one example of a suitable computing environment and is not intended to suggest any limitation as to the scope of use or functionality of the present technology. Neither should the computing environment be interpreted as having any dependency or requirement relating to any one or combination of components illustrated in the example computing system 600.

The present technology may be described in the general context of computer executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer storage media including memory-storage devices.

### GNSS Receiver

With reference now to FIG. 7, a block diagram is shown of an embodiment of an example GNSS receiver which may be used in accordance with various embodiments described herein. In particular, FIG. 7 illustrates a block diagram of a GNSS receiver in the form of a general purpose GPS receiver 780 capable of demodulation of the L1 and/or L2 signal(s) received from one or more GPS satellites. For the purposes of the following discussion, the demodulation of L1 and/or L2 signals is discussed. It is noted that demodulation of the L2 signal(s) is typically performed by “high precision” GNSS receivers such as those used in the military and some civilian applications. Typically, the “consumer” grade GNSS receivers do not access the L2 signal(s). Further, although L1 and L2 signals are described, they should not be construed as a limitation to the signal type; instead, the use of the L1 and L2 signal(s) is provided merely for clarity in the present discussion.

Although an embodiment of a GNSS receiver and operation with respect to GPS is described herein, the technology is well suited for use with numerous other GNSS signal(s) including, but not limited to, GPS signal(s), Glonass signal(s), Galileo signal(s), and BeiDou signal(s).

The technology is also well suited for use with regional navigation satellite system signal(s) including, but not limited to, Omnistar signal(s), StarFire signal(s), Centerpoint signal(s), Doppler orbitography and radio-positioning integrated by satellite (DORIS) signal(s), Indian regional navigational satellite system (IRNSS) signal(s), quasi-zenith satellite system (QZSS) signal(s), and the like.

Moreover, the technology may utilize various satellite based augmentation system (SBAS) signal(s) such as, but not limited to, wide area augmentation system (WAAS) signal(s), European geostationary navigation overlay service (EGNOS) signal(s), multi-functional satellite augmentation system (MSAS) signal(s), GPS aided geo augmented navigation (GAGAN) signal(s), and the like.

In addition, the technology may further utilize ground based augmentation systems (GBAS) signal(s) such as, but not limited to, local area augmentation system (LAAS) signal(s), ground-based regional augmentation system (GRAS) signals, Differential GPS (DGPS) signal(s), continuously operating reference stations (CORS) signal(s), and the like.

Although the example herein utilizes GPS, the present technology may utilize any of the plurality of different navigation system signal(s). Moreover, the present technology may utilize two or more different types of navigation system signal(s) to generate location information. Thus, although a GPS operational example is provided herein it is merely for purposes of clarity.

In one embodiment, the present technology may be utilized by GNSS receivers which access the L1 signals alone, or in combination with the L2 signal(s). A more detailed discussion of the function of a receiver such as GPS receiver 780 can be found in U.S. Pat. No. 5,621,426. U.S. Pat. No. 5,621,426, by Gary R. Lennen, entitled “Optimized processing of signals for enhanced cross-correlation in a satellite positioning system receiver,” which includes a GPS receiver very similar to GPS receiver 780 of FIG. 7.

In FIG. 7, received L1 and L2 signal is generated by at least one GPS satellite. Each GPS satellite generates different signal L1 and L2 signals and they are processed by different digital channel processors 752 which operate in the same way as one another. FIG. 7 shows GPS signals (L1=1575.42 MHz, L2=1227.60 MHz) entering GPS receiver 780 through a dual frequency antenna 701. Antenna 701 may be a magnetically mountable model commercially available from Trimble® Navigation of Sunnyvale, Calif., 94085. Master oscillator 748 provides the reference oscillator which drives all other clocks in the system. Frequency synthesizer 738 takes the output of master oscillator 748 and generates important clock and local oscillator frequencies used throughout the system. For example, in one embodiment frequency synthesizer 738 generates several timing signals such as a 1st LO1 (local oscillator) signal 1400 MHz, a 2nd LO2 signal 175 MHz, a (sampling clock) SCLK signal 25 MHz, and a MSEC (millisecond) signal used by the system as a measurement of local reference time.

A filter/LNA (Low Noise Amplifier) 734 performs filtering and low noise amplification of both L1 and L2 signals. The noise figure of GPS receiver 780 is dictated by the performance of the filter/LNA combination. The downconverter 736 mixes both L1 and L2 signals in frequency down to approximately 175 MHz and outputs the analogue L1 and L2 signals into an IF (intermediate frequency) processor 30. If processor 750 takes the analog L1 and L2 signals at approximately 175 MHz and converts them into digitally sampled L1 and L2 inphase (L1 I and L2 I) and quadrature signals (L1 Q and L2 Q) at carrier frequencies 420 KHz for L1 and at 2.6 MHz for L2 signals respectively.

At least one digital channel processor 752 inputs the digitally sampled L1 and L2 inphase and quadrature signals. All digital channel processors 752 are typically identical by design and typically operate on identical input samples. Each digital channel processor 752 is designed to digitally track the L1 and L2 signals produced by one satellite by tracking code and carrier signals and to form code and carrier phase measurements in conjunction with the microprocessor system 754. One digital channel processor 752 is capable of tracking one satellite in both L1 and L2 channels.

Microprocessor system 754 is a general purpose computing device which facilitates tracking and measurements processes, providing pseudorange and carrier phase measurements for a navigation processor 758. In one embodiment, microprocessor system 754 provides signals to control the operation of one or more digital channel processors 752. Navigation processor 758 performs the higher level function of combining measurements in such a way as to produce position, velocity and time information for the differential and surveying functions. Storage 760 is coupled with navigation processor 758 and microprocessor system 754. It is appreciated that storage 760 may comprise a volatile or non-volatile storage such as a RAM or ROM, or some other computer readable memory device or media.

One example of a GPS chipset upon which embodiments of the present technology may be implemented is the Maxwell™ chipset which is commercially available from Trimble® Navigation of Sunnyvale, Calif., 94085.

### Differential GPS

Embodiments described herein can use Differential GPS to determine position information with respect to a jib of the tower crane. Differential GPS (DGPS) utilizes a reference station which is located at a surveyed position to gather data and deduce corrections for the various error contributions which reduce the precision of determining a position fix. For example, as the GNSS signals pass through the ionosphere and troposphere, propagation delays may occur. Other factors which may reduce the precision of determining a position fix may include satellite clock errors, GNSS receiver clock errors, and satellite position errors (ephemeredes).

The reference station receives essentially the same GNSS signals as rovers which may also be operating in the area. However, instead of using the timing signals from the GNSS satellites to calculate its position, it uses its known position to calculate errors in the respective satellite measurements. The reference station satellite errors, or corrections, are then broadcast to rover GNSS equipment working in the vicinity of the reference station. The rover GNSS receiver applies the reference station satellite corrections to its respective satellite measurements and in so doing, removes many systematic satellite and atmospheric errors. As a result, the rover GNSS receiver position estimates are more precisely determined. Alternatively, the reference station corrections may be stored for later retrieval and correction via post-processing techniques.

### Real Time Kinematic System

An improvement to DGPS methods is referred to as Real-time Kinematic (RTK). The present technology employs RTK, however, in one embodiment, the working angle of the crane is determined without using RTK. As in the DGPS method, the RTK method, utilizes a reference station located at determined or surveyed point. The reference station collects data from the same set of satellites in view by the rovers in the area. Measurements of GNSS signal errors taken at the reference station (e.g., dual-frequency code and carrier phase signal errors) and broadcast to one or more rovers working in the area. The rover(s) combine the reference station data with locally collected carrier phase and pseudo-range measurements to estimate carrier-phase ambiguities and precise rover position. The RTK method is different from DGPS methods primarily because RTK is based on precise GNSS carrier phase measurements. DGPS methods are typically based on pseudo-range measurements. The accuracy of DGPS methods is typically decimeter-to meter-level; whereas RTK techniques typically deliver cm-level position accuracy.

RTK rovers are typically limited to operating within 70 km of a single reference station, Atmospheric errors such as ionospheric and tropospheric errors become significant beyond 70 km. “Network RTK” or “Virtual Reference Station” (VRS) techniques have been developed to address some of the limitations of single-reference station RTK methods.

### Network RTK

Network RTK typically uses three or more GNSS reference stations to collect GNSS data and extract spatial and temporal information about the atmospheric and satellite ephemeris errors affecting signals within the network coverage region. Data from all the various reference stations is transmitted to a central processing facility, or control center for Network RTK. Suitable software at the control center processes the reference station data to infer how atmospheric and/or satellite ephemeris errors vary over the region covered by the network. The control center computer then applies a process which interpolates the atmospheric and/or satellite ephemeris errors at any given point within the network coverage area. Synthetic pseudo-range and carrier phase observations for satellites in view are then generated for a “virtual reference station” nearby the rover(s).

The rover is configured to couple a data-capable cellular telephone to its internal signal processing system. The surveyor operating the rover determines that he needs to activate the VRS process and initiates a call to the control center to make a connection with the processing computer. The rover sends its approximate position, based on raw GNSS data from the satellites in view without any corrections, to the control center. Typically, this approximate position is accurate to approximately 4-7 meters. The surveyor then requests a set of “modeled observables” for the specific location of the rover. The control center performs a series of calculations and creates a set of correction models that provide the rover with the means to estimate the ionospheric path delay from each satellite in view from the rover, and to take into account other error contributions for those same satellites at the current instant in time for the rover's location. In other words, the corrections for a specific rover at a specific location are determined on command by the central processor at the control center and a corrected data stream is sent from the control center to the rover. Alternatively, the control center may instead send atmospheric and ephemeris corrections to the rover which then uses that information to determine its position more precisely.

These corrections are now sufficiently precise that the high performance position accuracy standard of 2-3 cm may be determined, in real time, for any arbitrary rover position. Thus the GNSS rover's raw GNSS data fix can be corrected to a degree that makes it behave as if it were a surveyed reference location; hence the terminology “virtual reference station.” An example of a network RTK system which may be utilized in accordance with embodiments described herein is described in U.S. Pat. No. 5,899,957, entitled “Carrier Phase Differential GPS Corrections Network,” by Peter Loomis, assigned to the assignee of the present patent application.

The Virtual Reference Station method extends the allowable distance from any reference station to the rovers. Reference stations may now be located hundreds of kilometers apart, and corrections can be generated for any point within an area surrounded by reference stations.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What we claim is:

1. A non-transitory computer readable storage medium having instructions embodied therein that when executed cause a computer system to perform a method for providing guidance to a crane operator, said method comprising:
accessing identification information for a set of objects to be moved at a worksite and by a crane;
accessing inventory information associated with said worksite, wherein said inventory information comprises a location of said inventory at said worksite;
accessing routing information associated with said worksite, wherein said routing information comprises a set of routes available for movement of said inventory at said worksite, wherein said inventory includes said set of objects;
based on said identification information, said inventory information and said routing information, generating a lift plan for said set of objects, wherein said lift plan comprises a target destination and a target route for said set of objects; and
generating a 3-D simulation of said lift plan, wherein said 3-D simulation comprises a set of indicators providing an enhanced guidance for a movement of said set of objects.

2. The non-transitory computer readable storage medium as recited in claim 1, further comprising:
presenting said 3-D simulation of said lift plan at a display.

3. The non-transitory computer readable storage medium as recited in claim 1, wherein said accessing identification information occurs at a predefined periodic interval.

4. The non-transitory computer readable storage medium as recited in claim 1, wherein said accessing inventory information occurs at a predefined periodic interval.

5. The non-transitory computer readable storage medium as recited in claim 1, wherein said accessing routing information occurs at a predefined periodic interval.

6. The non-transitory computer readable storage medium as recited in claim 1, wherein said accessing identification information occurs after an initiation of an object identification request.

7. The non-transitory computer readable storage medium as recited in claim 6, wherein said initiation of said object identification request comprises sending a photograph of said set of objects to a device that is configured for providing said identification information.

8. The non-transitory computer readable storage medium as recited in claim 1, wherein said accessing identification information occurs after accessed inventory information indicates an inventory delivery to be made to said worksite.

9. The non-transitory computer readable storage medium as recited in claim 1, wherein said accessing routing information occurs after accessed inventory information indicates an inventory delivery to be made to said worksite.

10. The non-transitory computer readable storage medium as recited in claim 1, wherein said lift plan is generated according to a target lifting efficiency objective model.

11. The non-transitory computer readable storage medium as recited in claim 1, wherein said generating a 3-D simulation of said lift plan comprises:
generating a 3-D simulation of said lift plan from a bird's eye view.

12. The non-transitory computer readable storage medium as recited in claim 1, wherein said generating a 3-D simulation of said lift plan comprises:
generating a 3-D simulation of said lift plan from a point of view of said crane operator.

13. A crane operator guidance system configured for providing guidance to a crane operator for moving an object at a worksite, said crane operator guidance system comprising:
an identification information accessor coupled with a computer, said identification information accessor configured for accessing identification information for a set of objects to be moved at a worksite and by a crane;
an inventory information accessor coupled to said computer, said inventory information accessor configured for accessing inventory information associated with said worksite, wherein said inventory information comprises a location of said inventory at said worksite, wherein said inventory includes said set of objects;
a routing information accessor coupled to said computer, said routing information accessor configured for accessing routing information associated with said worksite, wherein said routing information comprises a set of routes available for movement of said set of objects at said worksite;
a lift plan generator coupled to said computer, said lift plan generator configured for, based on said identification information, said inventory information and said routing information, generating a lift plan for said set of objects, wherein said lift plan comprises a target destination and a target route for said set of objects; and
a 3-D lift plan simulation generator coupled to said computer, said 3-D lift plan simulation generator configured for generating a 3-D simulation of said lift plan, wherein said 3-D simulation comprises a set of indicators providing an enhanced guidance for a movement of said set of objects.

14. The crane operator guidance system of claim 13, further comprising:
a 3-D simulation presenter coupled to said computer, said 3-D simulation presenter configured for presenting said 3-D simulation of said lift plan at a display.

15. The crane operator guidance system of claim 13, further comprising:
a time clock coupled to said computer, said time clock configured for sending an activation signal to at least one of said identification information accessor, said inventory information accessor, and said routing information accessor when a predefined time has expired, wherein said activation signal prompts an activation of at least one of said accessing said identification information, aid accessing said inventory information and said accessing said routing information.

16. The crane operator guidance system of claim 13, further comprising:
an object identification request initiator coupled to said computer, said object identification request initiator configured for initiating a request for an object identification by sending a photograph of said set of objects to a device that is configured for providing said identification information.

17. The crane operator guidance system of claim 16, wherein said object identification request initiator comprises:
a photograph sender configured for sending a photograph of said set of objects to a device that is configured for providing said identification information.

18. The crane operator guidance system of claim 13, further comprising:
a target efficiency objective model generator coupled to said computer, said target efficiency objective model generator configured for generating said lift plan comprising at least a most efficient method for moving said set of objects to said target destination along said target route, wherein said generating is based on at least said identification information, said inventory information and said routing information.

19. The crane operator guidance system of claim 18, wherein said at least a most efficient method comprises:
a fastest time to move said set of objects to said target destination.

20. The crane operator guidance system of claim 18, wherein said at least a most efficient method comprises:
a fastest time to accomplish a completion of a portion of a project at said worksite, wherein said completion of said portion of said project includes moving said set of objects to said target destination.

21. The crane operator guidance system of claim 13, wherein said 3-D simulation comprises:
a 3-D simulation presented from a perspective of a bird's eye view of said worksite.

22. The crane operator guidance system of claim 13, wherein said 3-D simulation comprises:
a 3-D simulation presented from a perspective of a point of view of said crane operator.

23. The crane operator guidance system of claim 13, wherein said set of indicators comprises:
a set of visual indicators.

24. The crane operator guidance system of claim 13, wherein said set of indicators comprises:
a set of audio indicators.
